(19) United States
(12) Patent Application Publication
(10) Pub. No.: US 2026/0048496 A1
(43) Pub. Date: Feb. 19, 2026

(54) HIGH-TEMPERATURE RESISTANT ROBOT FOR HAZARDOUS ENVIRONMENTS

(71) Applicant: Paradigm Robotics Corp., Austin, TX (US)

(72) Inventors: Siddharth Thakur, Austin, TX (US); Krishnan Ram, Austin, TX (US); James Joseph Mahon, VI, Austin, TX (US)

(21) Appl. No.: 18/936,931

(22) Filed: Nov. 4, 2024

Related U.S. Application Data
(60) Provisional application No. 63/682,760, filed on Aug. 13, 2024.

(51) Int. Cl. B25J 5/00; B25J 13/08; B25J 19/06

(52) U.S. Cl. CPC B25J 5/007; B25J 13/087; B25J 19/06

(57) ABSTRACT

A mobile robot system includes a thermal protection system comprising an anti-radiation surface coating applied to an exterior of the mobile robot system, and a passive thermal protection system (PTPS) disposed within an inner structure of a frame of the mobile robot system. The mobile robot system also includes an electronics thermal protection system (ETPS) disposed within the PTPS, and a temperature-hardened sensor housing comprising at least one sensor disposed externally on the frame. The mobile robot system additionally includes a control interface configured to control a mobile operation of the mobile robot system.

### CLAIM OF PRIORITY

This application claims the benefit of priority under 35 U.S.C. § 119 (e) to U.S. Provisional Patent Application Ser. No. 63/682,760, filed on Aug. 13, 2024, which is incorporated by reference herein in its entirety.

### TECHNICAL FIELD

The present disclosure generally relates to robots and more specifically to high-temperature resistant robots for hazardous environments.

### BACKGROUND

Robotic systems have been increasingly utilized in various industrial and emergency response applications. These systems often operate in challenging environments, including those with elevated temperatures, hazardous materials, and structural obstacles. However, the performance and durability of these systems can be significantly impacted by extreme conditions, particularly those involving high temperatures and corrosive substances.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 is a perspective view of a hazardous environment robot system, in accordance with some examples.

FIG. 2 is a block diagram of the hazardous environment robot system illustrating certain features of a Thermal Protection System (TPS), according to some examples.

FIG. 3A is a perspective view of a sensor housing disposed on a frame inner structure of the hazardous environment robot system, according to some examples.

FIG. 3B is a perspective view of a second sensor housing, according to some examples.

FIG. 4 is a perspective view of a frame inner structure that includes thermal expansion joints, according to some examples.

FIG. 5 illustrates further details of a thermally expandable corner joint, in accordance with some examples.

FIG. 6 depicts a perspective view of the hazardous environment robot system with additional drive system and other components, according to some examples.

FIG. 7 is a perspective view of electric motors and gearboxes, according to some examples.

FIG. 8 is a perspective view of a section of a gearbox, according to some examples.

FIG. 9 is a cutaway view of the high temperature co-axial spindle, according to some examples.

FIG. 10 is a perspective view of a high temperature co-axial spindle illustrating a cantilevered upright assembly section which is disposed inboard and an outboard section, according to some examples.

FIG. 11 is a perspective cutaway view illustrating a high temperature co-axial spindle disposed to drive a flipper arm and an inner track, according to some examples.

FIG. 12 is a perspective side view of a flipper arm, according to some examples.

FIG. 13 is a side view of a track cell, according to some examples.

FIG. 14 illustrates a perspective view of a subframe that is disposed inside of the hazardous environment robot system, according to some examples.

FIG. 15 is a perspective view of a vibration resistant high temperature switch and locking pin, according to some examples.

FIG. 16 is a cutaway side view of an internal electrical compartment (IEC) system, according to some examples.

FIG. 17 is a view of a base station firefighter control interface (FCI), according to some examples.

FIG. 18 is a front view of a handheld wireless interface system suitable for wireless control of a hazardous environment robot system, according to some examples.

FIG. 19 is a view of a base station antenna system suitable for communicating and/or operating the hazardous environment robot system from a base station location, according to some examples.

FIG. 20 is a block diagram depicting a machine suitable for executing instructions via one or more processors, according to some embodiments.

FIG. 21A is a side view of an example communications antenna 2102, according to some examples.

FIG. 21B is a sectional side view of the communications antenna, illustrating an inner antenna, according to some examples.

FIG. 22A is a perspective view of a busbar, according to some examples.

FIG. 22B is a perspective view of the bottom half of the busbar, according to some examples.

FIG. 23A is a perspective view of a high temp resistant strobe/illumination unit, according to some examples.

FIG. 23B is a perspective view of an interior of the high temp resistant strobe/illumination unit of FIG. 23A, according to some examples.

FIG. 24 is a perspective view of a sensor housing, in accordance to some examples.

FIG. 25A is a side perspective view of an external victim alert system (EVAS), according to some examples.

FIG. 25B is a side perspective view from behind a housing of an external victim alert system (EVAS) 2510, according to some examples.

FIG. 26A is a perspective backside view of a firefighter control interface (FCI), according to some examples.

FIG. 26B illustrates a front perspective view of the FCI of FIG. 26A, according to some examples.

FIG. 27 illustrates a radio mount, according to some examples.

FIG. 28 is a perspective view of a shroud, in accordance to some examples.

FIG. 29 illustrates an example of a hazardous environment robot system, according to some examples.

FIGS. 30-34 illustrate various view of a firefighter control interface (FCI), according to some examples.

### DETAILED DESCRIPTION

The present examples relate to a high-temperature resistant robot designed for operation in hazardous environments, particularly those involving structural fires and other extreme conditions. Traditional search-and-rescue (SAR) or inspection robots are often limited in their ability to withstand high temperatures and navigate difficult terrains. These conventional systems typically fail at temperatures exceeding 200° C., with their obstacle-climbing capabilities compromised at even lower temperatures.

Previous approaches to developing robots for hazardous environments have faced several challenges. One issue has been the thermal protection of sensitive electronic components. Conventional methods often rely on bulky insulation or limited exposure times, which restrict the robot's operational capabilities and duration in high-temperature zones. Additionally, the materials used in traditional robot construction, such as rubber tracks and standard electrical components, are prone to failure or degradation when exposed to extreme heat or corrosive substances. Another challenge has been the development of sensor systems capable of functioning reliably in smoke-filled or high-temperature environments. Traditional optical and gas sensors often struggle to provide accurate data in these conditions, limiting the robot's ability to gather information for search-and-rescue operations or hazardous material detection.

The present disclosure addresses these challenges through a novel multi-layered approach to thermal protection and specialized component design. The robot incorporates a High Reflectivity Surface Coating (HRSC), a Passive Thermal Protection System (PTPS), and an Electronics Thermal Protection System (ETPS) to manage both external and internal heat loads more effectively. In some examples, the HRSC is an electroplated surface coating with either a high reflection coefficient (e.g., >0.9) or a high emissivity coefficient (e.g., >0.9), designed to reflect radiative heat loads and minimize heat transfer to the robot's chassis. This coating aids in maintaining the integrity of the robot at higher temperatures, particularly in structural fire environments where radiative heat is a factor.

The PTPS utilizes ceramic fiber blankets with low thermal conductivity to limit heat transfer from conductive and convective heat loads. These blankets enclose thermally sensitive components and fill empty volumes within the robot's chassis, more effectively slowing the rate of heat transfer. The selection of these materials also considers the need for a lightweight design, which improves the robot's mobility and maneuverability. The ETPS is designed to dissipate heat generated within the robot, as well as any residual heat that penetrates the PTPS. It employs a paraffin-wax-based organic phase change material, described in more detail below, which stores heat during an endothermic chemical reaction. This material is contained between concentric metal boxes, with the inner box housing the electronics (Inner Electronics Capsule or IEC). The IEC is additionally plated with a high-emissivity coating to enhance heat transfer from the electronics to the phase change material.

Another innovation in the robot's design is the high-temperature resistant container for external-facing electronics and sensors. This container allows sensors to interact with the external environment while being protected from high-temperature effects. It incorporates a thermal band-pass filter on the glass cover to restrict radiation, along with strategic placement of insulation and electronic components. This design enables the use of sensors that would typically fail at temperatures encountered by the robot.

The robot's mechanical and propulsive systems are also engineered to withstand high temperatures. This includes a high-temperature co-axial spindle system that allows for the rotation of flipper arms while maintaining thermal protection for sensitive components. The flipper arm system, located on the external of each of the four axles, can rotate almost 360 degrees, enabling the robot to climb stairs, obstacles, and debris. Further, a drive system incorporates a multi-directional front or rear wheel drive, allowing the robot to shift its center of gravity for improved climbing or descending capabilities. Special attention has been given to the design of bearings and fittings to account for thermal expansion and maintain functionality at high temperatures.

To protect the electric motors, a novel cooling system has been developed. This system encases the motors in a housing filled with the phase change material (PCM), which absorbs heat and protects the motor from external heat sources. A copper piece effectively distributes heat from the motor into the PCM tank. The motor housing also incorporates a multi-level cork gasket system for additional cooling and protection.

The robot's frame and chassis additionally incorporate thermal braking techniques to mitigate heat transfer throughout the structure. This includes the use of multiple alloys and materials joined together to create thermal boundaries, as well as a mica washer stack system used throughout the robot to reduce heat transfer at connection points. Indeed, the concepts of using mica and various materials all serve for heat braking. Mica is disposed between a metal, thus aiding heat breaking. Further, the mechanical design (the gaps, spaces, and tolerances) all serve to slow heat down via reduced contact points. Further, an accounting for expansion of heat can be performed, via coefficients of thermal expansion (CTE's), so that the mobile robot system presented herein is highly heat tolerant and can operate at 600 C or more for 15 minutes or more, or 200 C or more for 60 minutes or more.

In terms of electrical systems, the robot features a high-temperature antenna protection system, utilizing a multi-layer passive blanket system with a dielectric radome. Custom high-temperature cables and connectors have been developed for both signal and power transmission, enabling reliable operation in extreme heat conditions. The robot's sensor suite includes a variety of high-temperature resistant components, including thermal and optical cameras, gas sensors, and audio systems. Another novel aspect of the sensor design is the potential for wireless sensors integrated into the tracks, such as Hall effect sensors and inertial measurement units (IMUs), to improve positional control, navigation, and odometry readings.

Software innovations include sensor fusion algorithms that combine thermal and optical data to improve resolution and image quality, as well as algorithms for autonomous people detection in challenging environments. The robot also employs smart algorithms to balance processing between onboard systems and external computing resources. The robot's power system consists of a high-capacity battery that allows for longer runtimes at maximum speed, enabling untethered operation in hazardous environments. A multi-stage power safety system with layered fault detection protects the electronics from cascading failures.

The high-temperature resistant robot system described herein represents an advancement in the field of robotics for hazardous environments. Its multi-layered thermal protection system, specialized mechanical and electrical components, and advanced sensor and software capabilities enable it to operate more effectively in conditions that would render conventional robots inoperable. This technology has potential applications in firefighting, industrial inspection, and other scenarios involving extreme temperatures and hazardous materials.

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

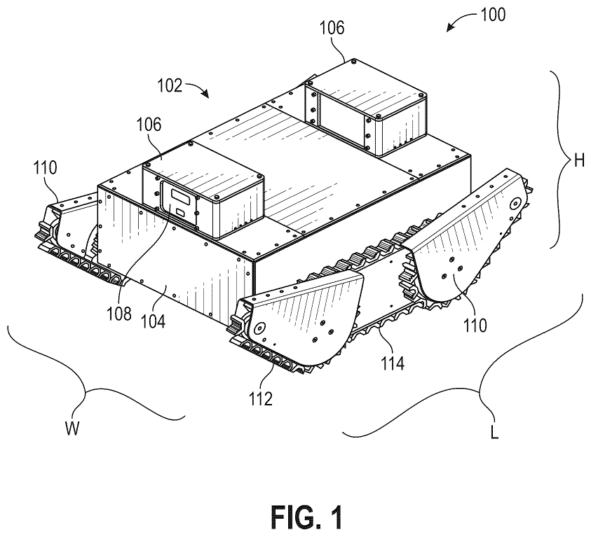

Turning now to FIG. 1, the figure is a perspective view of a hazardous environment robot system 100, in accordance with some examples. In the depicted example, the hazardous environment robot system 100 includes a frame 102 enclosed by a metal cladding 104. That is, the hazardous environment robot system 100 is covered with the metal cladding 104, which serves as part of its thermal protection system. The metal cladding 104 incorporates a high reflectivity surface coating (HRSC) with a high reflection coefficient (>0.9) and/or a high emissivity coefficient (>0.9), designed to reflect radiative heat loads and minimize heat transfer to the robot's interior. It is to be understood that, in some examples, the HRSC can include multiple coatings. The hazardous environment robot system 100 is equipped with a sensor array used to drive, navigate, and search in hazardous environments, such as a residential structure fire, among others. In the depicted example, sensor housings 106 house one or more sensors, including optical sensors (e.g., visible light cameras), thermal sensors, gas and hazardous material sensors, radar-based sensors (e.g., LIDAR), and so on. The sensor housing 106 is a high-temperature resistant container that includes an observation area 108 to restrict radiation while allowing specific wavelengths to pass through for sensor operations.

The hazardous environment robot system 100 features four flipper arms 110, one on each side (front, back, left, and right). These flipper arm 110 include tracks 112, allowing navigation over obstacles, the climbing of stairs, and traversing debris. The flipper arms 110 can rotate almost 360 degrees and are capable of locking in position. Tracks 114 are also provided, and are disposed on both sides of the frame 102. The tracks 112, 114 are high-temperature resistant metal tracks, which include certain features, further described below, that aid the robot in climbing large obstacles such as stairs. The hazardous environment robot system 100 has an overall symmetrical design, allowing for multi-directional movement. This design enables the hazardous environment robot system 100 to be “front” or “rear” driven, shifting its center of gravity as needed for improved climbing or descending capabilities. A tank-drive system, such as that provided by inner tracks, allows turning in place.

The hazardous environment robot system 100, in the depicted example, is provided at a size that enable navigation inside common structures such as a residence or a commercial building. Accordingly, the hazardous environment robot system 100 has a length L of between 1 and 6 ft., a width W of between 1 and 4 ft., and a height H of between 1 and 3 ft. In use the hazardous environment robot system 100 is designed to carry 300 lbs. or more and to tow 250 lbs. or more, and is additionally built to withstand harsh conditions, including being dropped or flipped over. The hazardous environment robot system 100 is not affected much by flames due to the frame 102 and further hardening techniques described in more detail blow. The hazardous environment robot system 100 is also a bulletproof robot having a NIJ class IIIA bullet proof/resistance using AR500 steel. The hazardous environment robot system 100 can be fully contaminated (doused with chemicals) and then cleaned by dousing with water. The hazardous environment robot system 100 is further designed to be class 1 division 1, ATEX, IECE-X explosion plus hazardous zone safe. Additionally, the hazardous environment robot system 100 is designed to be class 1 division 1, ATEX, IECE-X intrinsically safe. The hazardous environment robot system 100 is also dust-tight and water resistant, thus it can be splashed and/or sprayed lightly. The hazardous environment robot system 100 is also bulletproof (NIJ IIIA+), water resistant (IP67) using mica gaskets, rugged (built to withstand a roof collapse and tremendous stresses and impact forces), and anti corrosive (using only stainless steel) in certain examples. The hazardous environment robot system 100 is also modular, with the ability to add various sensors, baskets, attachments, tools, and so on.

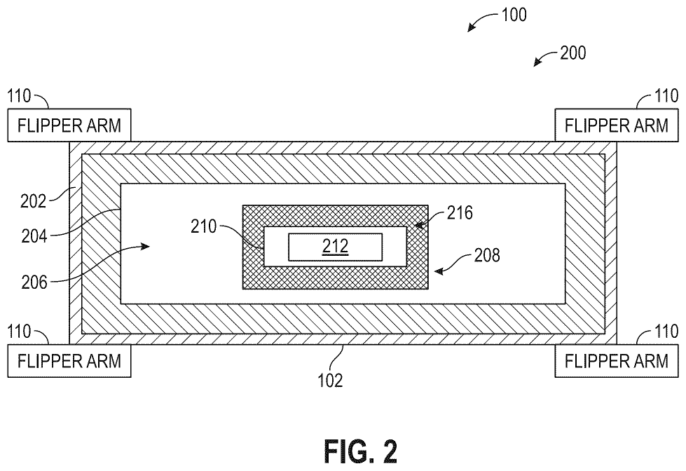

As mentioned earlier, hazardous environment robot system 100 include various levels and types of thermal protection. Turning now to FIG. 2, the figure is a block diagram of the hazardous environment robot system 100 illustrating certain features of a Thermal Protection System (TPS) 200, according to some examples. The TPS 200 protects the internals of the hazardous environment robot system enables the operation of the hazardous environment robot system 100 while being exposed to high temperatures, for example, during mobile operations in a burning fire while protecting electronic as well as mechanical components. The TPS 200 described herein includes novel arrangements, orientations, and housing of materials in certain ratios to maximize protection against both external heat loads and internal heat generation from the electronic systems.

In one example, the TPS 200 includes a High Reflectivity Surface Coating (HRSC) 202 that is used to coat the frame or chassis 102. In some examples, the HRSC 202 includes several layers, the outermost layer being an electroplated surface coating with either a high reflection coefficient (>0.9) or a high emissivity coefficient (>0.9), in both cases serving to physically reflect radiative heat loads, thus minimizing heat transferred to the robot's chassis. In some examples, the element 202 refers to a multi-layered insulation (MLI) which goes on the exterior of the robot, which is part of an external Temperature Protection system (XTPS) of which the final layer is the high temperature highly radiative surface coating HRSC. Other layers included in the MLI are ceramic layers, high temperature metal layers (e.g., (e.g., tungsten, molybdenum, nickel, and the like), and/or ceramics (e.g., silicon carbide, boron carbide, boron nitride), or a combination thereof. In some examples, the MLI is made of multiple coatings, with the final coating being the HRSC. Other coatings include stainless steel coatings, ceramic coatings, high temperature paint, and so on. At structural fire temperatures, the bulk of the thermal load tends to be radiative as per the Stefan-Boltzmann Law, so the HRSC 202 aids in guaranteeing the integrity of the robot at higher temperatures.

The TPS 200 additionally includes a Passive Thermal Protection System (PTPS), and Electronics Thermal Protection System (ETPS). The hazardous environment robot system 100 manages both external heat from flames, as well as internal heat generated by the electronics (radios, batteries, sensors, and the like). The HRSC 202 addresses external radiative heat, the PTPS manages external conductive/convective heat, and the ETPS manages all internally generated heat.

In the depicted example, the PTPS includes a fire-temperature optimized insulation 204 (e.g., specced to 600 C or more for 15 minutes or more, or 200 C or more for 60 minutes or more) and a conduction-zone (e.g., low conductivity zone) insulation 206 (specced to 600 C or more for 15 minutes or more, or 200 C or more for 60 minutes or more). Indeed, the entire robot system 100 is designed to withstand temperatures of 600 C or more for 15 minutes or more, or 200 C or more for 60 minutes or more. The fire-temperature optimized insulation 204 and conduction-zone insulation 206 includes ceramic fire blankets selected due to their low thermal conductivity. In some examples, the ceramic fire blankets withstand fire temperatures of 2400° F. or more, and include fibers are typically made from a combination of alumina (Al₂O₃) and silica (SiO₂). These ceramic fire blankets enclose thermally sensitive components and more generally fill the empty volume inside the chassis 102, thus decreasing the rate of heat and protecting the sensitive components. Furthermore, the ceramic blankets have been chosen for low density to improve weight characteristics of the hazardous environment robot system 100.

The ETPS, on the other hand, dissipates heat within the hazardous environment robot system 100—both the remaining heat after PTPS mitigation as well as generated heat from internal electronics. That is, in some examples, the PTPS includes an electronic “capsule” 208 designed to withstand high temperatures. The electronics capsule 208 fully encapsulates an electronics payload 212 between two metal boxes 210, 214. In certain examples, the space between the two metal boxes 210, 214 is filled with a paraffin-wax based organic phase change material (PCM) PCM 216, referred to as Salsolwax A28, which stores heat during an endothermic chemical reaction. More specifically, the PCM 216 is a chemically oxidized hard wax that consists largely of straight chain hydrocarbons and that exhibits a high melting point combined with a low viscosity. In depicted example, the inner box 210, also referred to as the Inner Electronic Capsule (IEC), is plated with a surface coating that increases the emissivity of the inner box 214, allowing for improved heat transfer from the IEC 210 to the PCM 216. Other PCM materials to use include all liquid to solid PCMs, liquid to liquid PCMs, and solid to solid PCMs. An example of solid to solid PCM includes graphite-based solid to solid PCM, such as an epoxy-graphite flakes composite.

By providing for a layer approach to thermal management, beginning with the HRSC 202, the fire-temperature optimized insulations 204, the conduction-zone insulation 206, the electronics capsule 208, and the dual boxes 210, 214, and the PCM 216, the techniques described herein enable the hazardous environment robot system 100 to operate at higher temperatures and for longer duration. Indeed, the hazardous environment robot system 100 can operate surrounded by fire at temperatures of 1200° F. or more for 15 minutes or more. Additionally, the hazardous environment robot system 100 can operate at temperatures of 400 F or more twelve times longer than a firefighter wearing National Fire Protection Association (NFPA) 1971 standard regulation bunker suits. Additionally, the techniques described herein provide for enhanced sensing operations while in a hazardous environment, as described in more detail below.

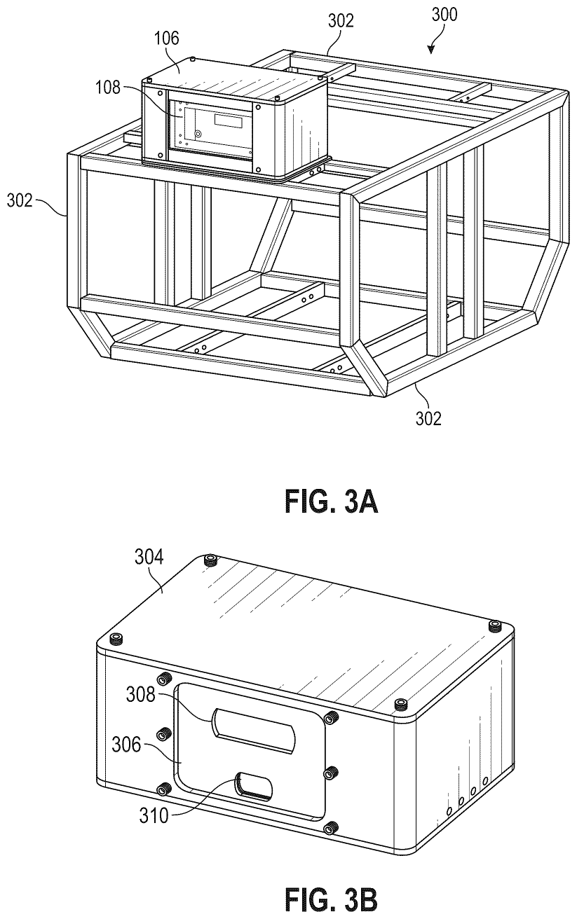

Turning now to FIG. 3A, the figure is a perspective view of the sensor housing 106 disposed on a frame inner structure 300 of the hazardous environment robot system 100, according to some examples. In the depicted example, the sensor housing 106 is illustrated as a rectangular box mounted on top of the frame inner structure 300. The sensor housing 106 contains the hazardous environment robot system's optical and vision sensors, including 360-degree view coverage cameras, high-zoom optical cameras with night vision capabilities, and high-resolution thermal cameras.

The sensor housing 106 shows the observation area 108 as a transparent or semi-transparent front panel, which corresponds to a thermal band-pass filter designed to restrict radiation entering the observation area 108 while allowing specific wavelengths to pass through for sensor operations. Sensors and other electronics tend to fail at elevated temperatures, some as low as 60° C. Traditional thermal protection systems for electronics are large and bulky while restricting the ability of the electronics to interact with the external environment. This is particularly problematic when it comes to sensing, where such interaction is necessary. The sensor housing 106 allows for various sensors to interact with the external environment while being protected from high temperature effects in a compact form factor. In certain examples, this is accomplished with a combination of a thermal band-pass filter on the glass cover which restricts radiation, as well through strategic placement of insulation (e.g., ceramic blanket insulation) and electronic components.

In some examples, the sensor housing 106 is 5 mm thick, 110 mm long, and 70 mm wide, and provides minimal thermal expansion. Various options are provided for the observation area 108. In one option, both visible and IR band pass filters are used, and both are on one continuous glass of the above dimensions. In a second option, one piece of glass with two separate treatments for allowing two groups of wavelengths through is provided, one on each half (55×70 mm), with one half for visible light and a second half for IR. In a third option, two separate pieces sized 55×70 mm are provided, one that enables transmission of visible light and one for IR. For the IR side or piece used, the wavelength allowed through is selected based on a desired IR thermal camera used, such as an 8-14 micrometer IR thermal camera used.

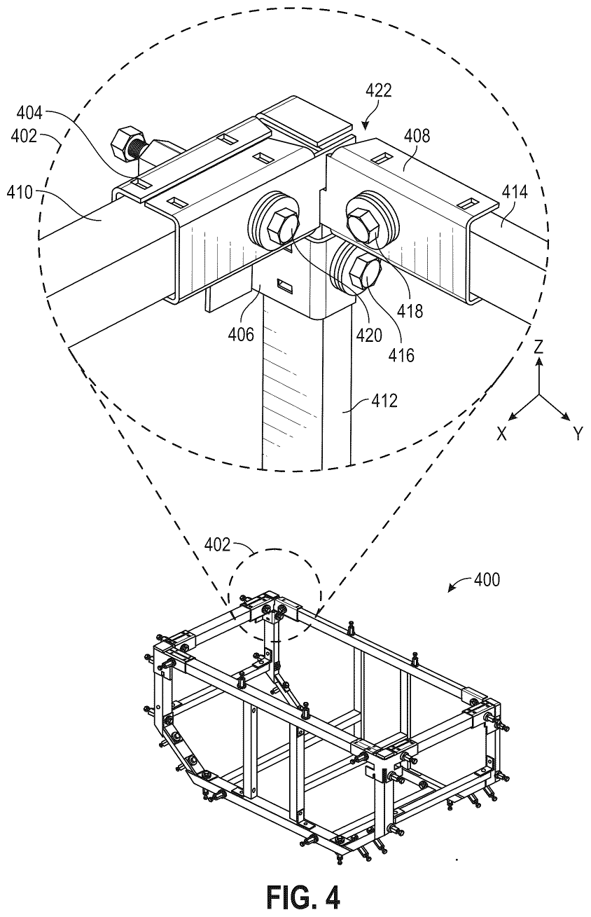

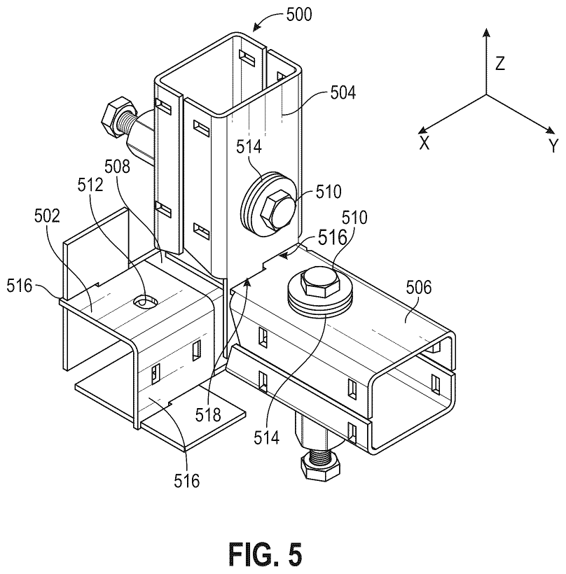

The frame inner structure 300 is shown as a robust, cage-like framework constructed from metal tubing or struts 302. In some examples, the struts 302 are rectangularly-shaped hollow struts that reduce the overall weight of the hazardous environment robot system 100. This frame inner structure 300 forms the skeleton of the robot's chassis 102, providing support for various components and contributing to the robot's overall durability. In some examples, the frame inner structure 300 includes certain expansion joints, as described below with respect to FIGS. 4 and 5, that enable a thermal expansion and contraction of the hazardous environment robot system 100 for improved operations during a variety of thermal environments.

FIG. 3B is a perspective view of a second sensor housing 304 that may be used in lieu of the sensor housing 106, according to some examples. In the depicted example, the second sensor housing 304 has an observation area 306 that provides for two observation windows 308, 310. Each observation window 308, 310 can include visible and/or IR band pass filters. As mentioned above, each observation window 308, 310, can, in one option, provide both visible and/or IR band pass filters, either in one continuous glass, or in two separate glasses (e.g., one for window 308, a second for window 310). For the IR side or piece used, the wavelength allowed through is selected based on a desired IR thermal camera used, such as an 8-14 micrometer IR thermal camera used.

FIG. 4 is a perspective view of a frame inner structure 400 that includes thermal expansion joints, according to some examples. Conventional methods of joining structural metal tubing, such as welding and bolting, present issues at high temperatures due to the unequal expansion of the joint and tubing respectively. This may result in stresses that can be detrimental to the structural integrity and functionality of a metal body. A novel tube-joining system that allows for thermal expansion while retaining the structural strength of a tubing frame through compliance of specifically arranged and custom made springs is shown.

In the depicted embodiment, a corner joint 402 is shown, which is designed to accommodate thermal expansion without the use of welds. The corner joint 402 includes multiple interlocking pieces, such as metal springs interlocking pieces, which fit together without welding. Three tubular frame members 410, 412, 414 converge at the corner joint 402, each coming from a different axis (X, Y, and Z). Each frame member 410, 412, 414 ends in a specially designed fitting of the respective metal springs 404, 406, 408 that interlocks with the others.

The fittings have flanged ends with bolt holes suitable for securing the frame members 410, 412, 414 via one or more bolts 416, 418, 420 as opposed to welds. There are gaps 422 between the interlocking fittings, which allow for thermal expansion and contraction of the metal as temperatures change. The design incorporates one or more connecting pieces that joins all three interlocking pieces 404, 406, 408 together. By avoiding welds and allowing for thermal expansion, the frame inner structure 400 can more easily maintain its structural integrity while accommodating the extreme temperature changes it may encounter. The use of bolted connections instead of welds also provides for a modular design approach, which would facilitate casier assembly, maintenance, and replacement of components.

FIG. 5 illustrates further details of a thermally expandable corner joint 500, in accordance with some examples. In the depicted example, three interlocking pieces 502, 504, 506, are disposed at 90° to each other, for example, via connecting pieces 508. In addition to a friction fit coupling between the interlocking pieces 502, 504, 506 and the connecting pieces 508, tabs 516 are disposed inside of respective slots to provide for thermal expansion and/or contraction.

The interlocking piece 504 is a hollow, rectangular tube that forms the vertical element of the joint. It has multiple slots or openings along its length, both for weight reduction and to allow for thermal expansion. The slots in the interlocking pieces 502, 504, 506 provide space for the metal to expand and contract with temperature changes minimizing or eliminating structural stress. The interlocking pieces 502, 506 are two perpendicular, hollow, rectangular tubes that intersect with the vertical member. These also feature slots or openings similar to the vertical member.

Fastening structures such as bolts 510 are visible on faces of the interlocking pieces 504, 506. In some examples, these bolts 510 aid in fastening the corner joint 500 components together, replacing traditional welding methods. A through-hole or opening 512 is also shown, used to insert a bolt through the interlocking piece 502. Mica washer stacks 514 sized to receive the bolts 510 are used to provide a thermal barrier that reduces heat transfer.

Tabs or extensions 516 are shown, which are inserted into respective slots to align and guide movement of certain components. Gaps 518 between components are also shown. These visible spaces between the interlocking pieces 502, 504, 506 accommodate dimensional changes due to thermal expansion. The corner joint 500 addresses the challenges of operating in high-temperature environments. By allowing for thermal expansion and contraction, it helps maintain the hazardous environment robot system's structural integrity and functionality across a wide range of temperatures. The modular, bolt-together approach additionally facilitates easier assembly, maintenance, and replacement of components, which aligns with the hazardous environment robot system's design philosophy for adaptability in various hazardous environments.

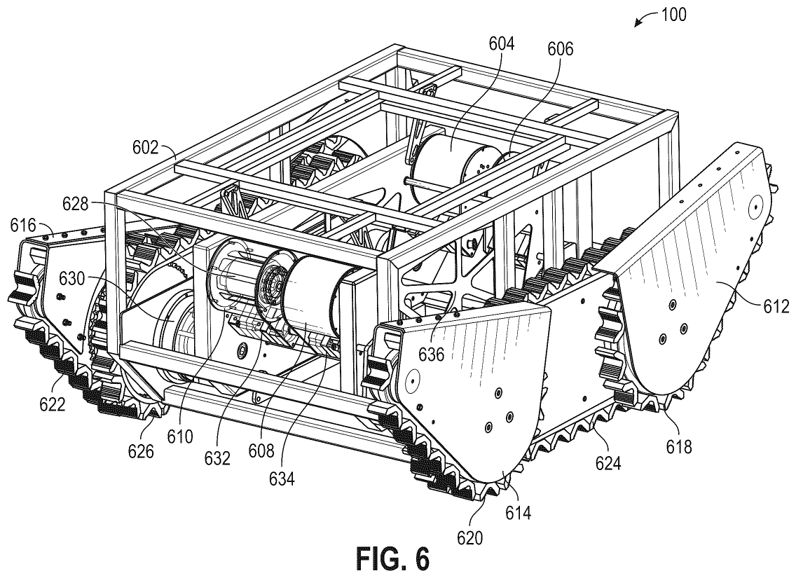

FIG. 6 depicts a perspective view of the hazardous environment robot system 100 with additional drive system and other components, according to some examples. In the depicted embodiment, a frame inner structure 602 forms the skeleton of the hazardous environment robot system 100, designed to withstand high temperatures and provide structural support for various components. The hazardous environment robot system 100 drive system includes four electric motors 604, 606, 608, 610 positioned within the frame inner structure to drive flipper arms, such as flipper arms 612, 614, 616, flipper arm tracks 618, 620, 622, as well as inner tracks 624, 626.

In some examples, the electric motors 604, 606, 608, 610 are 1100 Watt peak power motors, enabling the hazardous environment robot system 100 to achieve speeds of 12 ft/s (8 mph) or more and providing high maneuverability. In the depicted example, the hazardous environment robot system 100 is fully symmetric, thus allowing it to be “front” or “rear” driven and allowing it to shift its center of gravity forward or backwards, which is beneficial to climb or descend stairs. All of the flipper arms, including the flipper arms 612, 614, 616, rotate close to 360°, thus not only more easily climbing stairs and overcoming various obstacles, but additionally suitable for righting the hazardous environment robot system 100 when the hazardous environment robot system 100 is flipped upside down.

Electric motor 610 is shown with its cover removed, revealing an armature 628. The armature 628 is used for brushless direct current (DC) driving of the electric motors 604, 606, 608, 610 motors, providing for enhanced efficiency and durability in harsh environments. The positioning of the electric motors 604, 606, 608, 610 within the frame inner structure 602 follows the hazardous environment robot system's symmetrical design, allowing for the multi-directional front or rear wheel drive system described earlier. This symmetric positioning enables the robot to shift its center of gravity forward or backward, which is particularly beneficial for climbing or descending stairs and navigating uneven terrain.

Also shown are a high temperature co-axial spindle 630, and high temperature thermal braking gearboxes 632, 634, used as part of the hazardous environment robot system's drive system. The gearboxes 632, 634 and co-axial spindle 630 provide for rotary motion of the flipper arms 612, 614, 616, and motive power for the tracks 618, 620, 622, 624, 626. A high temperature subframe 636 is also shown, which mitigates the transfer of heat as described in more detail below.

The overall layout of the motors and frame structure results in a more compact and efficient design for the hazardous environment robot system 100, suitable for its operation in hazardous and high-temperature environments. This configuration allows for the integration of the multi-layered thermal protection system, including the High Reflectivity Surface Coating (HRSC), Passive Thermal Protection System (PTPS), and Electronics Thermal Protection System (ETPS), while maintaining the hazardous environment robot system's mobility and functionality.

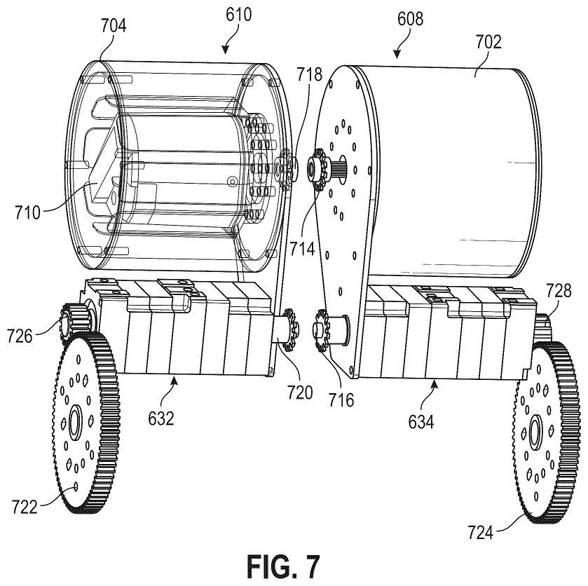

FIG. 7 is a perspective view of the electric motors 608, 610 and the gearboxes 632, 634, according to some examples. In the depicted example, the electric motors 608, 610 each include a phase change material (PCM) cover 702, 704, respectively. The electric motor 610 is depicted with its PCM housing or cover 704 exposed, revealing the internal motor 710. In use, the internal motor 710 is surrounded (e.g., completely surrounded) by phase change material, and the phase change material and internal motor 710 are all enclosed via the PCM housing or cover 702. Indeed, these PCM housing or covers 702, 704 are designed to be filled with phase change material to absorb heat and protect the motors from external heat sources. There is a copper piece (not shown) that distributes heat from the electric motors 608, 610 into a tank effectively. There is a seal around the electric motors 608, 610 that is a high temperature seal and has high thermal conductivity but is waterproof, preventing phase change material from entering the into other areas. There is a multilevel cork gasket system for motor cooling and protection. The electric motors 608, 610 are replaceable modular drive units.

The gearboxes 632, 634 are shown as rectangular structures positioned below the motors. In some examples, these gearboxes 632, 634 are mechanically coupled to the electric motors 608, 610 via chains connected to gears 714, 716, and 718, 720. In the depicted example, the gearboxes 632, 634 drive gears 722, 724 through direct interfaces with gears 726, 728, respectively. The gearboxes 632, 634 use special tolerances, fits, and designs to allow for thermal expansion and contraction in high temperatures while preventing excessive heat from reaching the motors.

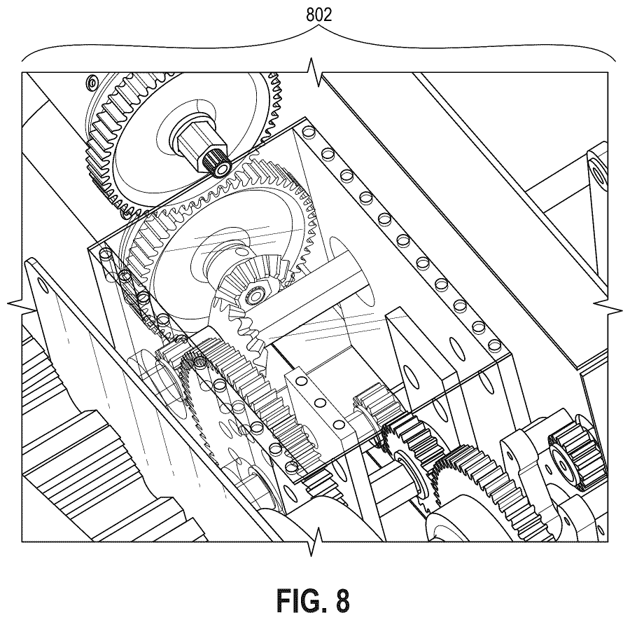

FIG. 8 is a perspective view of a section 802 of one of the gearboxes 632, 634, according to some examples. Section 802 is illustrative of a complex arrangement of interlocking gears of various sizes, designed to provide the necessary power transmission and speed reduction for the hazardous environment robot system's drive system. The figure shows multiple gear stages having gears of different sizes, indicating a multi-stage gear reduction system. This design allows for significant torque multiplication and speed reduction, providing for the hazardous environment robot system 100 high-power, high-maneuverability capabilities.

Some of the gears include spur gears, characterized by straight teeth radiating out from the center of the gear. This design is known for its efficiency and strength, suitable for the high-stress environment in which the hazardous environment robot system 100 operates. The figure also illustrates a more compact arrangement of gears packed within the gearbox (e.g., gearbox 632). The gears are likely constructed from high-temperature resistant materials, including titanium, nickel, Inconel, and/or stainless steel to withstand the more extreme conditions that the hazardous environment robot system 100 encounters. Thermal tolerances and meshing of the gears are engineering to maintain functionality under thermal stress and ensure smooth power transmission.

While not explicitly shown, the gearbox can include a specialized high-temperature lubrication system to maintain gear performance and longevity in extreme conditions. Accordingly, the gearbox design enhances the hazardous environment robot system's ability to operate in high-temperature environments, providing for power transmission while managing thermal expansion and maintaining structural integrity.

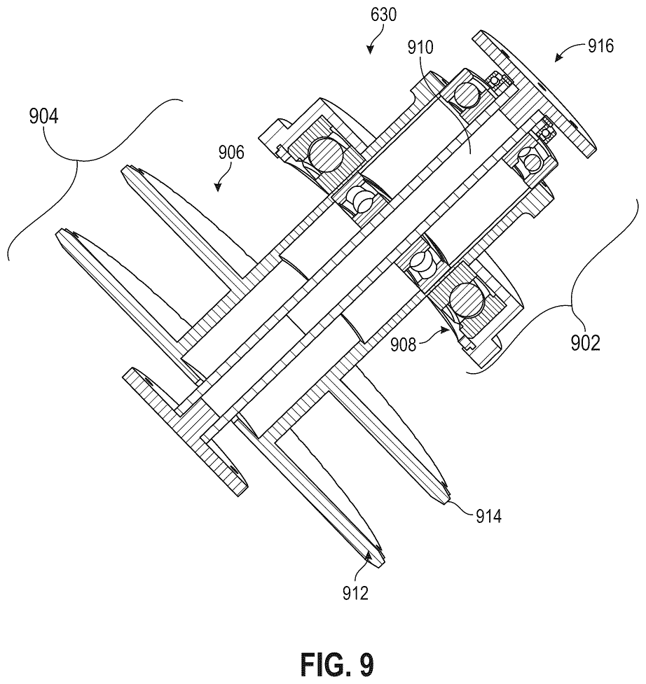

FIG. 9 is a cutaway view of the high temperature co-axial spindle 630, according to some examples. In the depicted example, the high temperature co-axial spindle 630 is shown as a cylindrical structure with multiple internal components, including a cantilevered upright assembly 902 section. The high temperature co-axial spindle 630 incorporates a cantilevered design that keeps thermally sensitive components inboard while maintaining stiffness and strength on the outboard side 904. This arrangement protects certain components from higher outside temperatures while ensuring mechanical integrity. The figure also illustrates a rotation mechanism 906, which in the cutaway view reveals the internal bearings and mechanisms that allow for the almost 360-degree rotation capability of the flipper arms. This rotation provides for the robot's ability to navigate obstacles and climb stairs.

The cutaway view additionally reveals several high-temperature bearings 908. That is, the high temperature co-axial spindle 630 incorporates custom-designed high-temperature bearing fittings. These fittings account for thermal expansion and maintain proper tolerances between bearings 908 and parts in high-temperature environments. Thermal braking features are also provided. For example, the high temperature co-axial spindle 630 includes thermal braking techniques, such as the use of multiple alloys and materials joined together to limit heat transfer. This include the use of materials like titanium, nickel, Inconel, and/or stainless steel to create thermal boundaries.

Sealing mechanisms are also provided, such as high-temperature seals and gaskets to prevent the ingress of hazardous materials and maintain the integrity of the internal components. Additionally, a drive mechanism includes a columnar member 910 that provides motive force used to turn gears 912, 914 via a mechanical coupling to the hazardous environment robot system's drive system, including gearing or other power transmission components at end 916. The high temperature co-axial spindle 630 balances mechanical strength, thermal management, and operational flexibility.

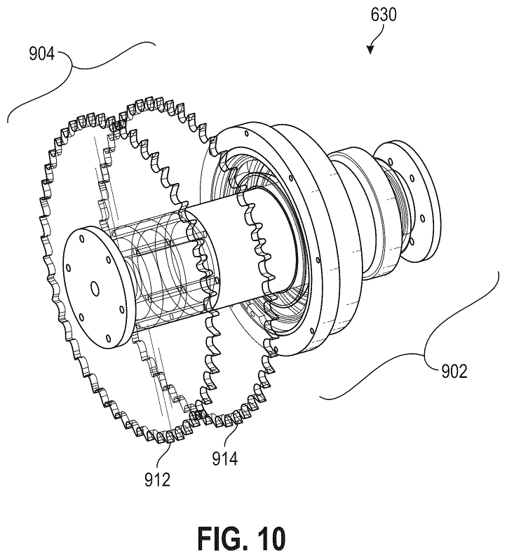

It may be beneficial to illustrate the high temperature co-axial spindle 630 in a non-cutaway view. Turning now to FIG. 10, the figure is a perspective view of the high temperature co-axial spindle 630 illustrating the cantilevered upright assembly 902 section which is disposed inboard and the outboard section 904, according to some examples. The inboard section 902 is protected from higher heat by virtue of being located fully inside of the outer frame (e.g., frame 102), of the hazardous environment robot system 100. The outer section 904 then interfaces with a flipper arm and/or an inner track. For example, the gear 912 is used to drive the flipper arm while the gear 914 is used to drive the inner track.

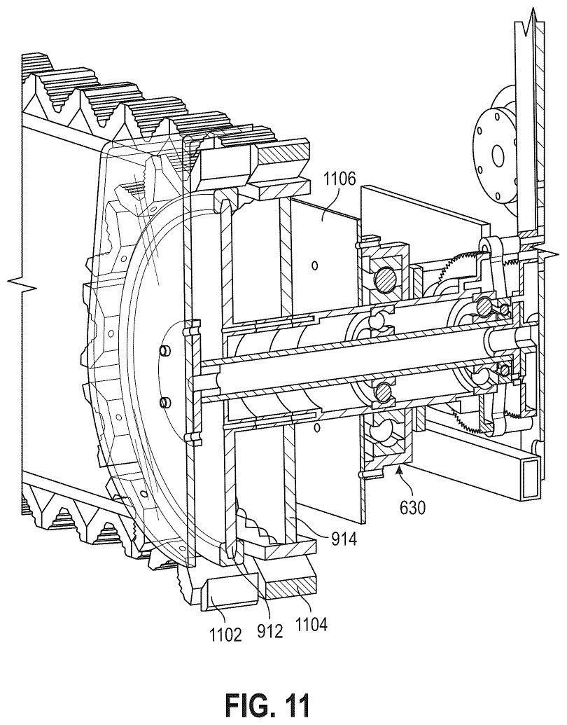

FIG. 11 is a perspective cutaway view illustrating the high temperature co-axial spindle 630 disposed to drive a flipper arm and an inner track, according to some examples. In the depicted example, gear 912 is shown as engaged to a track 1102 of the flipper arm, and the 914 is shown as engaged to a track 1104 of the inner track. A wall section 1106 is also shown, that separates interior sections of the hazardous environment robot system 100 from the outside environment. In some examples, the wall section 1106 is a component of a frame, such as the frame 102. A stack of bolts, fasteners, and mica washers (which are a thermal barrier and reduce heat transfer) are used throughout the hazardous environment robot system 100 to eliminate or reduce heat transfer.

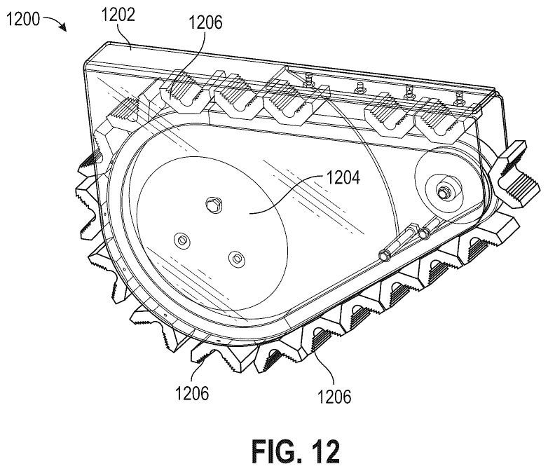

Turning now to FIG. 12, the figure is a perspective side view of a flipper arm 1200, according to some examples. In the depicted example, the flipper arm 1200 is protected via a fender 1202, and is operatively coupled to a rotating member 1204 of the drive system included in the hazardous environment robot system 100. The flipper arm 1200 allows the hazardous environment robot system 100 to have pivot arms that are driven and are tracked to climb stairs, obstacles, and debris. Accordingly, multiple track cells 1206 are provided, which aid the flipper arm 1200 in climbing and navigating through stairs and other obstacles. In some examples, flipper arm 1200 locks in position. As shown earlier, flipper arm systems, such as the flipper arm 1200, are disposed on the external side of each of four axles of the hazardous environment robot system 100—the front and back, and left and right side. The flipper arm 1200 can rotate almost 360 degrees, thus providing from the ability to right the hazardous environment robot system 100 when upside down.

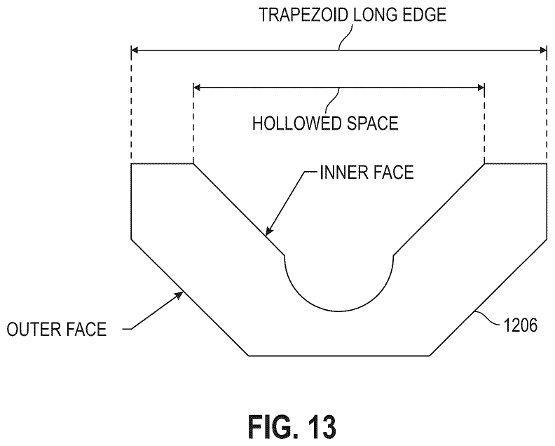

FIG. 13 is a side view of a track cell 1206, according to some examples. In the depicted example, the track cell 1206 has a trapezoidal shape with several features, including a trapezoid long edge, an outer face, an inner face, and a hollowed space. The trapezoid long edge forms the outer perimeter of the track cell 1206, and is designed to provide a surface area for traction and obstacle climbing. The outer face or exterior surface of the track cell 1206 can also come into direct contact with the terrain. The inner face or interior surface of the track cell 1206 interfaces with stair edges and other obstacles, aiding in “gripping” the edges or obstacles. In some embodiments, the inner face includes grooves or cuts to improve traction during track movement, as well as protrusions, such as “knobby” protrusions.

The hollowed space creates a void within the track cell 1206, serving multiple purpose. For example, the hollowed space enables a stair's edge to enter and make contact with the inner face, thus providing grip. The hollowed space additionally allows for thermal expansion and contraction in high-temperature environments, while providing certain weight reduction. The trapezoidal shape and hollowed design of this track cell 1206 represent a novel approach to high-temperature resistant locomotion systems. This design likely allows for improved obstacle climbing capabilities compared to conventional tank treads, while also accommodating the thermal expansion and contraction inherent in high-temperature operations.

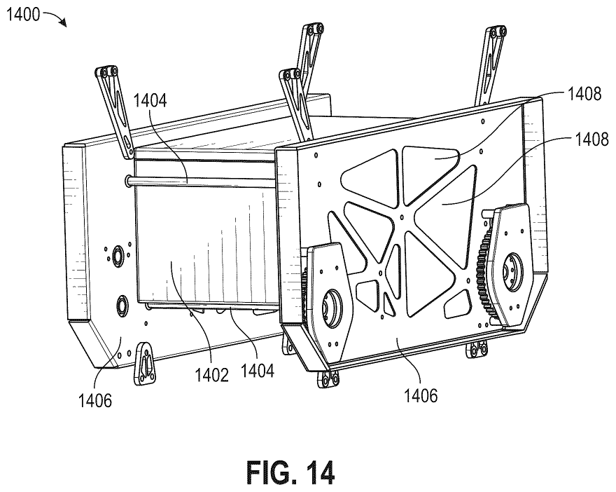

FIG. 14 illustrates a perspective view of a subframe 1400 that is disposed inside of the hazardous environment robot system 100, according to some examples. More specifically, the subframe 1400 is designed to be positioned inside of a frame inner structure, such as inside of the frame inner structures 300, 400, and the like. To prevent heat transfer to the sensitive electronics box (ETPS 1402)—the subframe 1400 is not attached to the ETPS 1402, in some examples. Instead, the ETPS 1402 sits in a carriage of rails or tubes 1404 connected to the subframe 1400 that hold the ETPS 1402 in place while minimizing heat transfer through aforementioned mica washer stacks.

The subframe 1400 includes side walls 1406 incorporating intricate geometric patterns that include cutouts or perforations 1408. These patterns serve multiple purposes, including allowing thermal expansions and contractions, reducing weight while maintaining structural integrity, and creating air pockets for insulation or heat transfer. In some examples, the side walls 1406 are constructed using a combination of high-temperature resistant materials such as titanium, nickel, Inconel, and stainless steel. This multi-material approach creates thermal boundaries to limit heat transfer.

The geometric patterns 1408 and material junctions act as thermal breaks, slowing the transmission of heat through the structure. This is achieved through discontinuities in the metal structure of the side walls 1406, using varying thicknesses in the frame components, and/or strategic placement of thermal insulation materials, such as ceramic insulation. The subframe 1400 also includes a variety of mounting points for attaching other robot components, such as motors, gearboxes, and electronic systems. These mounting points may incorporate additional thermal management features, such as insulating washers (e.g., mica washers) and/or thermal paste. The lid and the closeouts (panels) on the hazardous environment robot system 100 are sealed and use a mica gasket to be high temperature resistant and also water resistant and modular.

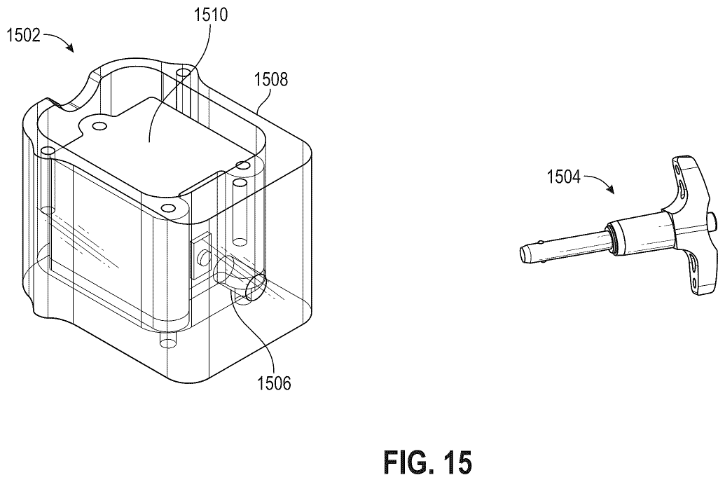

FIG. 15 is a perspective view of a vibration resistant high temperature switch 1502 and locking pin 1504, according to some examples. In the depicted examples, the vibration resistant high temperature switch 1502 includes an opening or tunnel 1506 through which the locking pin 1504 is inserted. When the locking pin 1504 is removed, the vibration resistant high temperature switch 1502 will turn off the hazardous environment robot system 100, thus acting as an emergency switch.

The vibration resistant high temperature switch 1502 includes a specialty thermal cage 1508 that encloses a high temperature limit switch 1510. The specialty thermal cage 1508 thermally protects and enables thermal braking and heat protection for the high temperature limit switch 1510. In some examples, the vibration resistant high temperature switch 1502 is positioned in an easily accessible location of the hazardous environment robot system 100, such as a top section of the hazardous environment robot system 100.

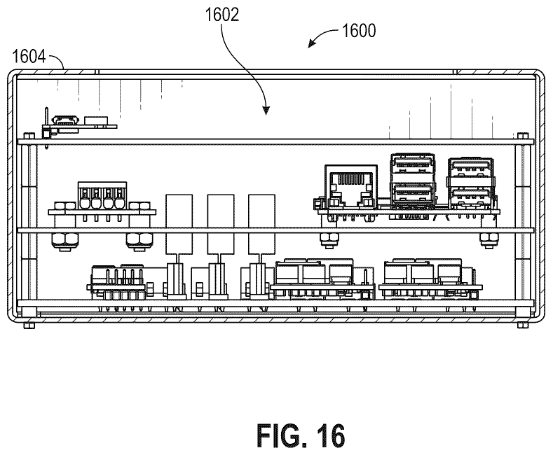

FIG. 16 is a cutaway side view of an internal electrical compartment (IEC) system 1600, according to some examples. The IEC 1600, in some examples, is equivalent to the box 210 of FIG. 2, or in inside of the box 210 of FIG. 2. Accordingly, the IEC 1600, in some examples, carries the electronics payload 212. In the depicted example, a modular stacked PCB system 1602 is shown as disposed inside of a housing 1604 (e.g., box 210) of the IEC system 1600. The modular stacked PCB system 1602 includes custom fittings, improved compactness, multiple connectors and connector types, as well as thermal protection and heat wicking. In some examples, the IEC system 1600 is thermally protected and completely waterproof. Boards disposed as layers of the stacked PCB system 1602 can include a high power board for robot power distribution that protects components, filtering voltages and currents, distributing power, and regulating voltage/current. In some examples, the high power board includes motor controller(s) suitable for driving, for example, the electric motors 604, 606, 608, 610 of FIG. 6. Circuits can also include a circuit attuned to internal structural fires that amplifies both speaker/siren output and microphone input. A low power for robot signal distribution board can also be included in the stacked PCB system 1602, that protect components, connects computer signals to sensors, distributing power, and keeping it compact. The sensors connecting to the IEC system 1600 include a 9-axis inertial measurement unit (IMU), a gyroscope, an accelerometer, a magnetometer, various gas sensors (e.g., Volatile Organic Compound (VOC) sensors), weather sensors (e.g., temperature sensors, humidity sensors, pressure sensors), as well as certain safety sensors (e.g., current sensors, voltage sensors), 2-way audio/speaker systems, acceleration sensors, global positioning system (GPS) sensors, as well as lights (e.g., strobe lights, high output lumen lights).

The hazardous environment robot system 100 also includes one or more embedded 2-way radios disposed in the IEC system 1600. The radios include custom radio protection, antenna connectors, a mounting and harness, and modular swappability. The radios are smart MIMO spatial multi-plexing high power radios with carefully chosen frequencies and parameters to allow for very deep internal structure wireless communication operation of the hazardous environment robot system 100 with high baud rate, low latency, high throughput, low signal to noise (SNR), and reliable communication. A system of high powered components with multi-layered triggered fault detection to protect electronics in the event of cascading failure is also included. Components include relay, fuses, and/or breakers. The hazardous environment robot system 100 further includes a custom microphone setup using a high temperature microphone that insulates in and protects it from the heat but also allows sound to pass through.

In some examples, the hazardous environment robot system 100 incorporates software algorithms that combine thermal and optical sensors to improve resolution and image quality. The algorithms also include algorithms for autonomous people detection, such as algorithms that use computer vision for human detection through multiple sensors. Algorithms further include algorithms for increasing thermal resolution and decreasing thermal washout. Algorithms additionally include algorithms that use computer vision to extrapolate thermal camera resolution as well as reduce thermal washout (screen becoming grey with lack of detail). Thermal cameras are protected and include support for operation at high temperature ranges as well as intelligently adjust contrast and temperature readings for various scenes.

High uniform temperature environments: All thermal image cameras (TICs) have a maximum dynamic range or temperature range and if the area within the field of view has reached this a firefighter will see no discernible details as the TIC has reached saturation. The TIC operates in high moisture content environments such as multiple sprinkler heads flowing in a cold smoke environment. This environment can create an image with no detail at all due to moisture build up on the lens that isn't wiped or cleared regularly. Low uniform temperatures which means the entire area within the field of view is the same temperature or similar temperatures. This creates a scene/image that is “washed out” with no or little detail. It can appear to be grey or white across the entire image. The cameras resolve images in these moisture-laden environments with features that clean the lens, such as remotely wipers, and/r rotating tape (tape rotates and brings new clean tape on top of lens).

Remote data monitoring of sensors-real time software is provided that allows for data monitoring on the FCI of sensors deployed on the hazardous environment robot system 100 in real time. Remote data monitoring of cameras, optical and thermals include software that allows for video monitoring on the FCI of optical sensors deployed on the robot in real time. Internal processing and external processing of cameras is used to further optimize heat generation, such as internal heat generation. Smart algorithms are used that allocate and balance processing data internally on the robot and externally on the FCI or cloud to minimize heat generation on the hazardous environment robot system 100. Cloud data storage and analysis-integration with incident command software as well as smart software that analyzes unique hazardous environment robot system 100 data in the cloud to provide insights and sharing capabilities and integrates with real time first responders or emergency response software (also referred to as incident command software). Software also includes communication software that uses router or hotspot techniques to have multiple hazardous environment robot systems meshed together, thus increasing communication distances.

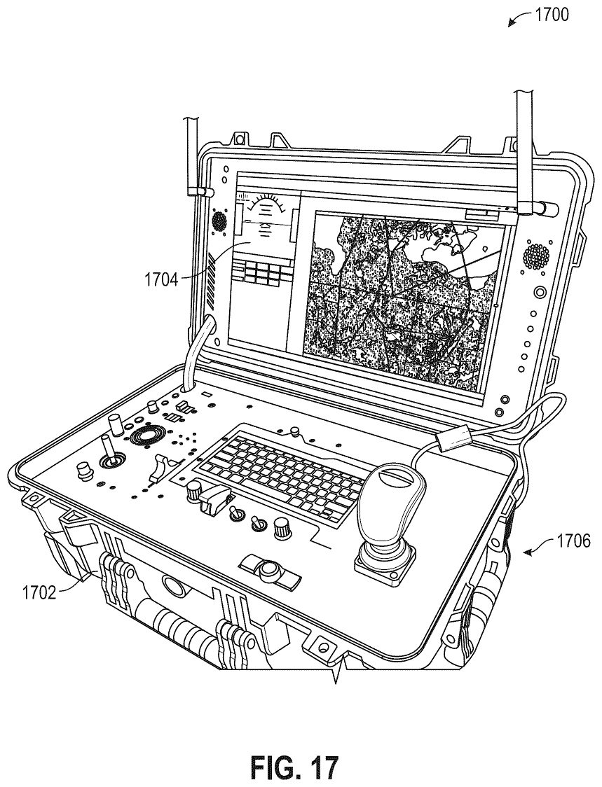

FIG. 17 is a view of a base station firefighter control interface (FCI) 1700, according to some examples. In the depicted example, the FCI 1700 is a briefcase-based FCI that includes a ruggedized enclosure. That is, the FCI 1700 is housed in a durable, briefcase-style enclosure 1702 designed to withstand harsh environments and provide protection for the internal components. The FCI 1700 includes a display screen 1704 that provides for a high-resolution screen disposed on the upper half of the FCI 1700, providing real-time video feed and other sensor data from the hazardous environment robot system's sensors. The display shows a satellite map view with overlaid information, including the hazardous environment robot system's position and environmental data.

A lower half 1706 of the FCI 1700 includes contains various control inputs, including: a full QWERTY keyboard for text input and command entry, a large joystick for more precise robot control, multiple knobs, buttons, and switches for various functions and mode selections. The FCI 1700 is battery-powered for portable operation in the field, and includes battery-related indicators (e.g., power indicators) and controls. The FCI 1700 incorporates wired and wireless communication systems to aid in maintaining a stable connection with the robot in challenging environments, including locations inside buildings and other structures. The FCI 1700, and indeed all FCI's described herein, provide for mobile operation control, such as moving the mobile robot system (forward, backward, turning), calling/listening via an external victim alert system (EVAS), turning on lights on a strobe/lighting unit, visualizing sensor readings, and so on.

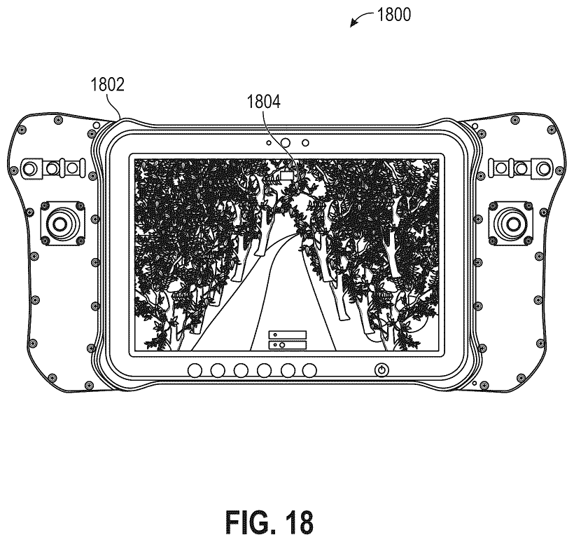

FIG. 18 is a front view of a handheld wireless interface system 1800 suitable for wireless control of the hazardous environment robot system 100, according to some examples. The handheld wireless interface system 1800 includes has a durable, impact-resistant housing 1802 designed to withstand harsh environments. It features reinforced corners and a textured grip surface for secure handling. The handheld wireless interface system 1800 also includes a high-resolution color screen 1804 disposed at the center of the device, providing real-time video feed and telemetry data from the hazardous environment robot system 100.

The handheld wireless interface system 1800 also includes dual joysticks positioned on either side of the display, allowing for precise control of the robot's movement and functions. Multiple control buttons are arranged around the display and joysticks, suitable for activating different hazardous environment robot system 100 functions and/or switching between control modes. An ergonomic design results in a shape to be comfortably held and operated with two hands, with controls positioned for easy access. While not visually apparent, the handheld wireless interface system 1800 incorporates wireless communication systems to maintain a stable connection with the robot in challenging environments. The handheld wireless interface system 1800 uses an internal battery power for portable operation in the field.

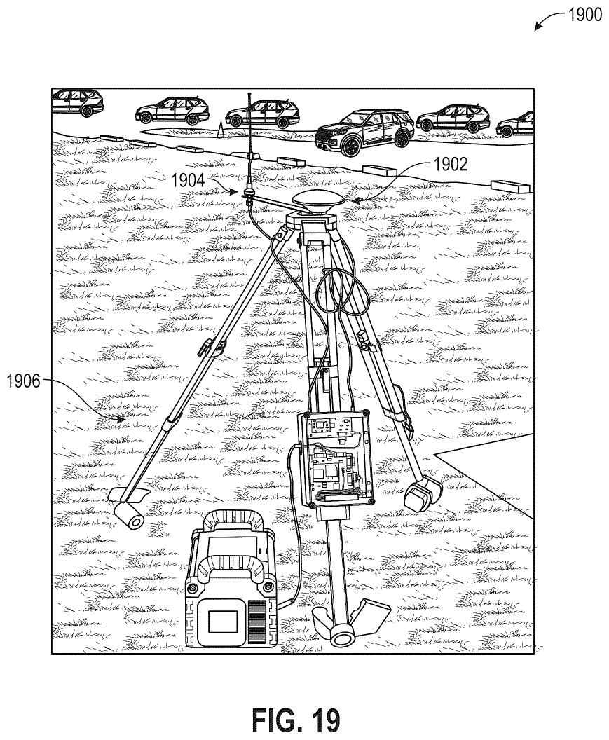

FIG. 19 is a view of a base station antenna system 1900 suitable for communicating and/or operating the hazardous environment robot system 100 from a base station location, according to some examples. In the depicted example, the base station antenna system 1900 includes a directional antenna 1902 and a non-directional antenna 1904 mounted on a tripod 1906, providing for enhanced stability and allowing for deployment on uneven terrain. This design enables quick setup in field conditions, and the tripod's adjustable leg allow operators to optimize the antenna height for improved signal propagation and to clear obstacles.

The directional antenna 1902 is in some examples a high-gain antenna designed to focus the signal in a specific direction. This enhances the range and reliability of communication with the robot in challenging environments. The base station antenna system 1900 is designed for portability, with the antenna and associated equipment compact enough to be easily transported and rapidly deployed at a fire ground or other site.

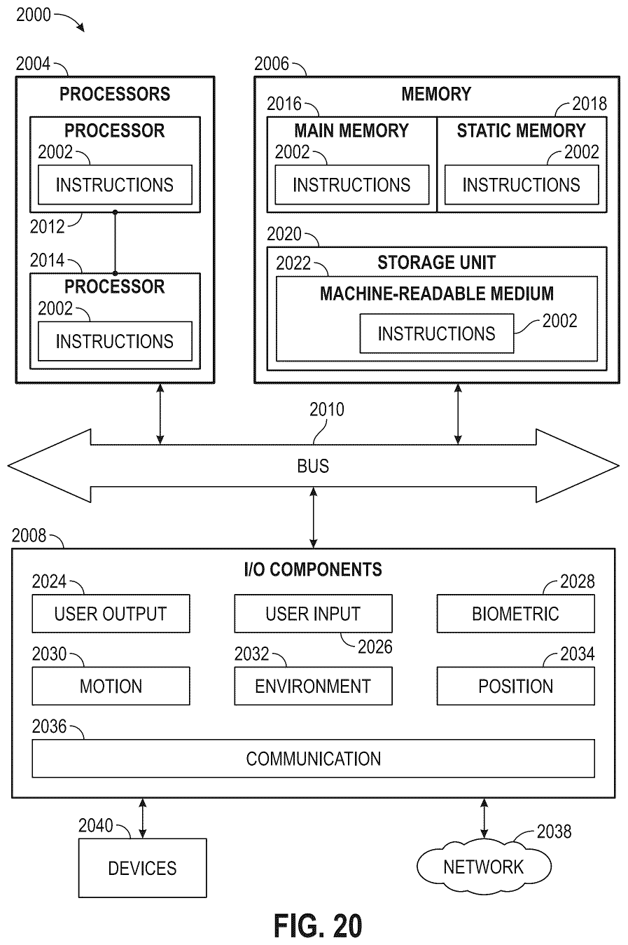

FIG. 20 is a diagrammatic representation of a machine 2000 within which instructions 2002 (e.g., software, a program, an application, an applet, an app, or other executable code) for causing the machine 2000 to perform any one or more of the methodologies discussed herein may be executed. For example, the instructions 2002 may cause the machine 2000 to execute any one or more of the processes or methods described herein. The instructions 2002 transform the general, non-programmed machine 2000 into a particular machine 2000. The machine 2000 may operate as a standalone device or may be coupled (e.g., networked) to other machines. In a networked deployment, the machine 2000 may operate in the capacity of a server machine or a client machine in a server-client network environment, or as a peer machine in a peer-to-peer (or distributed) network environment. The machine 2000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2002, sequentially or otherwise, that specify actions to be taken by the machine 2000. Further, while a single machine 2000 is illustrated, the term “machine” shall also be taken to include a collection of machines that individually or jointly execute the instructions 2002 to perform any one or more of the methodologies discussed herein. In some examples, the machine 2000 may also comprise both client and server systems, with certain operations of a particular method or algorithm being performed on the server-side and with certain operations of the particular method or algorithm being performed on the client-side.

The machine 2000 may include processors 2004, memory 2006, and input/output I/O components 2008, which may be configured to communicate with each other via a bus 2010. In an example, the processors 2004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 2012 and a processor 2014 that execute the instructions 2002. The term “processor” is intended to include multi-core processors that may comprise two or more independent processors (sometimes referred to as “cores”) that may execute instructions contemporaneously. Although FIG. 20 shows multiple processors 2004, the machine 2000 may include a single processor with a single-core, a single processor with multiple cores (e.g., a multi-core processor), multiple processors with a single core, multiple processors with multiples cores, or any combination thereof.

The memory 2006 includes a main memory 2016, a static memory 2018, and a storage unit 2020, both accessible to the processors 2004 via the bus 2010. The main memory 2016, the static memory 2018, and storage unit 2020 store the instructions 2002 embodying any one or more of the methodologies or functions described herein. The instructions 2002 may also reside, completely or partially, within the main memory 2016, within the static memory 2018, within machine-readable medium 2022 within the storage unit 2020, within at least one of the processors 2004 (e.g., within the processor's cache memory), or any suitable combination thereof, during execution thereof by the machine 2000.

The I/O components 2008 may include a wide variety of components to receive input, provide output, produce output, transmit information, exchange information, capture measurements, and so on. The specific I/O components 2008 that are included in a particular machine will depend on the type of machine. For example, portable machines such as mobile phones may include a touch input device or other such input mechanisms, while a headless server machine will likely not include such a touch input device. It will be appreciated that the I/O components 2008 may include many other components that are not shown in FIG. 20. In various examples, the I/O components 2008 may include user output components 2024 and user input components 2026. The user output components 2024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 2026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 2008 may include biometric components 2028, motion components 2030, environmental components 2032, or position components 2034, among a wide array of other components. For example, the biometric components 2028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2030 include acceleration sensor components (e.g., accelerometer), gravitation sensor components, rotation sensor components (e.g., gyroscope).

The environmental components 2032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2034 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2008 further include communication components 2036 operable to couple the machine 1200 to a network 2038 or devices 2040 via respective coupling or connections. For example, the communication components 2036 may include a network interface component or another suitable device to interface with the network 2038. In further examples, the communication components 2036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2040 may be another machine or any of a wide variety of peripheral devices (e.g., a peripheral device coupled via a universal serial bus (USB) port), internet-of-things (IOT) devices, and the like.

Moreover, the communication components 2036 may detect identifiers or include components operable to detect identifiers. For example, the communication components 2036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2036, such as location via Internet Protocol (IP) geolocation, location via Wi-Fi® signal triangulation, location via detecting an NFC beacon signal that may indicate a particular location, and so forth.

The various memories (e.g., main memory 2016, static memory 2018, and memory of the processors 2004) and storage unit 2020 may store one or more sets of instructions and data structures (e.g., software) embodying or used by any one or more of the methodologies or functions described herein. These instructions (e.g., the instructions 2002), when executed by processors 2004, cause various operations to implement the disclosed examples.

The instructions 2002 may be transmitted or received over the network 2038, using a transmission medium, via a network interface device (e.g., a network interface component included in the communication components 2036) and using any one of several well-known transfer protocols (e.g., hypertext transfer protocol (HTTP)). Similarly, the instructions 2002 may be transmitted or received using a transmission medium via a coupling (e.g., a peer-to-peer coupling) to the devices 2040. In some examples, the machine 2000 and/or the one or more of the devices 2040 at virtual reality devices, augmented reality devices, and/or mixed reality devices suitable for presenting the visualizations described herein.

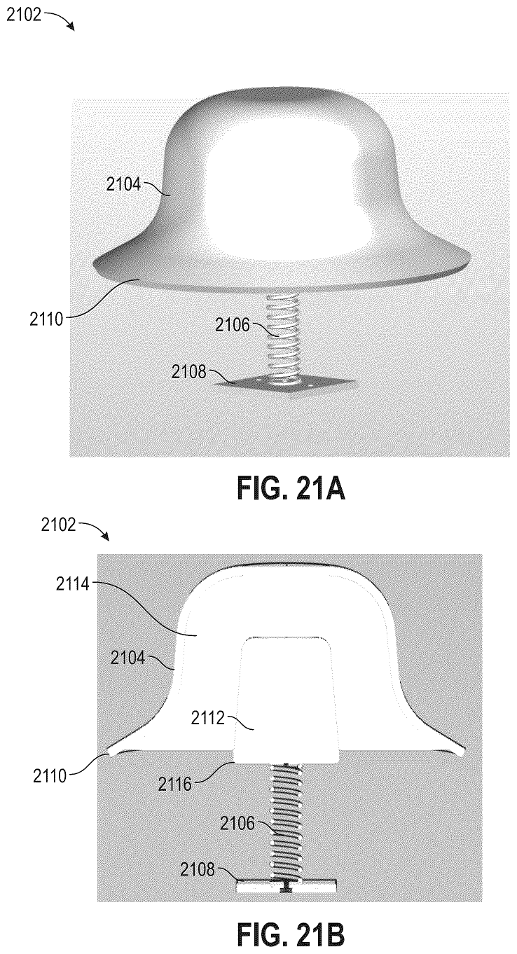

FIG. 21A is a side view of an example communications antenna 2102, according to some examples. In the depicted example, the communications antenna includes a protective shell 2104 that encapsulates an inner antenna structure described in more detail below. The protective shell 2104 can be manufactured of a heat resistant metal and its exterior surface then finished with a high reflectivity surface coating. In some examples, the protective shell 2104 has a “bell” shaped curved geometry that enable that aids in protecting the protective shell 2104 from “snagging” or otherwise catching external objects. The communications antenna 2102 includes a flexible member 2106 (e.g., spring) attached to a mounting plate 2108. The flexible member 2106 can move should the communications antenna 2102 “bump” against an external object, thus helping in protecting the communications antenna 2102. In some examples, the mounting plate 2108 can be mounted inside of the frame 102 at a vertical distance that enable all or substantially all of the flexible member 2106 to be protected by the metal cladding 104 that surrounds the frame 102. A bottom edge 2110 of the protective shell 2104 then rests against the metal cladding 104 but can slide about the metal cladding 104 should the protective shell 2104 abut against an external object.

FIG. 21B is a sectional side view of the communications antenna 2102, illustrating an inner antenna 2112, according to some examples. In the depicted example, the inner antenna 2112 is coupled to the protective shell 2104 via an interference fit and/or adhesives. In some examples, an interior 2114 of the protective shell is manufactured out of a heat resistant material, such as a ceramic, a metal, heat resistant fibers, and so on. As mentioned above, the edge 2110 of the protective shell 2104 rests against the metal cladding 104. Accordingly, the flexible member 2106 is disposed entirely inside of the frame 102. The metal cladding 104 includes an opening having a diameter larger than a diameter of a bottom section 2116 of the inner antenna 2112, enabling the inner antenna to protrude through the metal cladding 104 while also move about the metal cladding's plane should the protective shell 104 abut against an external object. The inner antenna 2112 is electrically coupled to electronics housed, for example, in the electronics capsule 208 and used to communicate with an external control interface, such as the firefighter control interface (FCI) 1700.

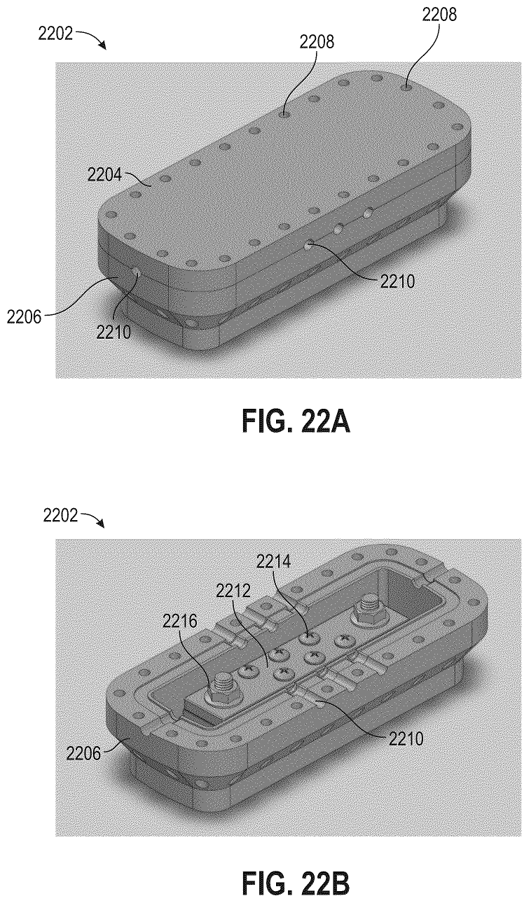

FIG. 22A is a perspective view of a busbar 2202, according to some examples. More specifically, the busbar 2202 is a submersible rated, sealed busbar for providing electrical power connections. The busbar 2202 is additionally low profile and IPx6 waterproof rated to prevent water from entering electronic systems. In the depicted embodiment, the busbar 2202 includes two halves, a top half 2204 and a bottom half 2206 that are joined to together to protect internal systems. In some examples, the busbar 2202 is manufactured out of high temperature material, such as manufacturing the halves 2204, 2206 out of high temperature metals (e.g., tungsten, molybdenum, nickel, and the like), ceramics (e.g., silicon carbide, boron carbide, boron nitride), or a combination thereof. Openings 2208 can be used to fasten the top half 2204 to the bottom half 2206 via screws, bolts/nuts, and so on. Openings 2210 provide conduits for cables and the like, that distribute electric power and/or signals.

FIG. 22B is a perspective view of the bottom half 2206 of the busbar 2202, according to some examples. In the depicted example, a metal bar 2212 is shown, suitable for conducting electricity. Various cables can be connected to the bar 2212 via screws 2214, bolts/nuts 2216, and the like, to provide electrical power and/or signals for distribution. Also shown are further details of the opening 2210. More specifically, the opening 2210 is created when half-circular notches on each half 2204, 2206 are joined together to create a circular (or similar shape) opening. One or more busbars 2202 are disposed inside of the frame 102 and used to distribute electrical power and/or signals.

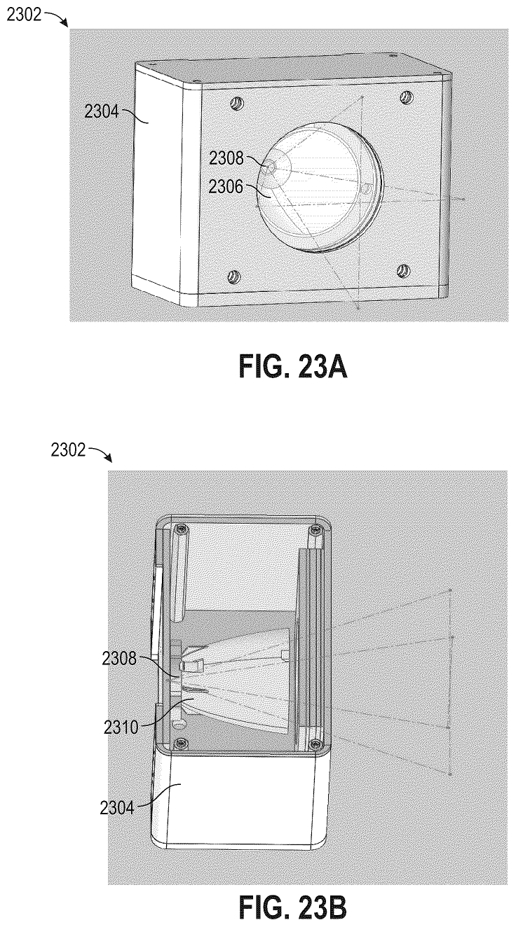

FIG. 23A is a perspective view of a high temp resistant strobe/illumination unit 2302, according to some examples. In the depicted example, a housing 2304 is shown, which can be manufactured of high temperature resistant materials like the aforementioned metals and/or ceramics. In some examples, a cover 2306 is used to protect a light source 2308. The light source 2308 can include light emitting diodes, incandescent bulbs, halogen lights, and the like. In use, the strobe/illumination unit 2302 can provide for a continuous light beam and/or for strobing light useful in identifying the hazardous environment robot system's presence as well as in illuminating the area(s) around the hazardous environment robot system. In FIG. 23B, a conical reflector 2310 is also shown, suitable for aiding transmission and/or focusing of light from the light source 2308. The one or more strobe/illumination units 2302 are placed at locations on the metal cladding 104, including forward, aft, top, and/or bottom locations of the hazardous environment robot system 100.

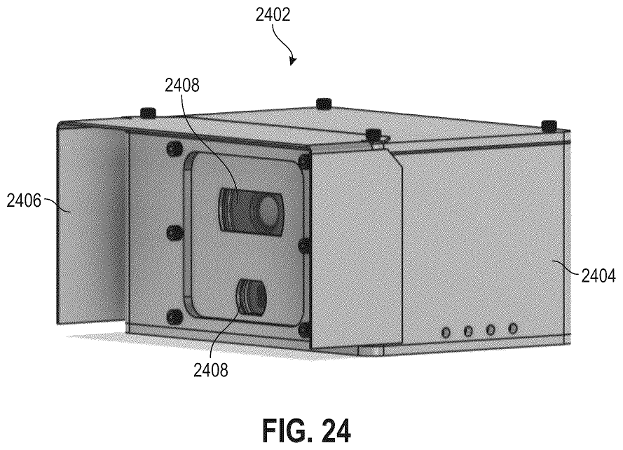

FIG. 24 is a perspective view of a sensor housing 2402, in accordance to some examples. In the depicted example, the sensor housing 2402 includes a visor 2406. More specifically, the visor 2406 has three sides (top, left side, right side) extending from a housing box 2404. A protective amorphous material transmitting in (AMTIR) glass 2408 is used as glass windows. The glass 2408 is an ultra high temperature glass that lets in long wave infrared (LWIR) wavelength light but blocks other frequencies, allowing the mitigation of radiative heat entering the system. The sensor housing 2402 includes the same or similar sensors as the sensor housing 106 and can be placed in the same or similar locations as the sensor housing 106.

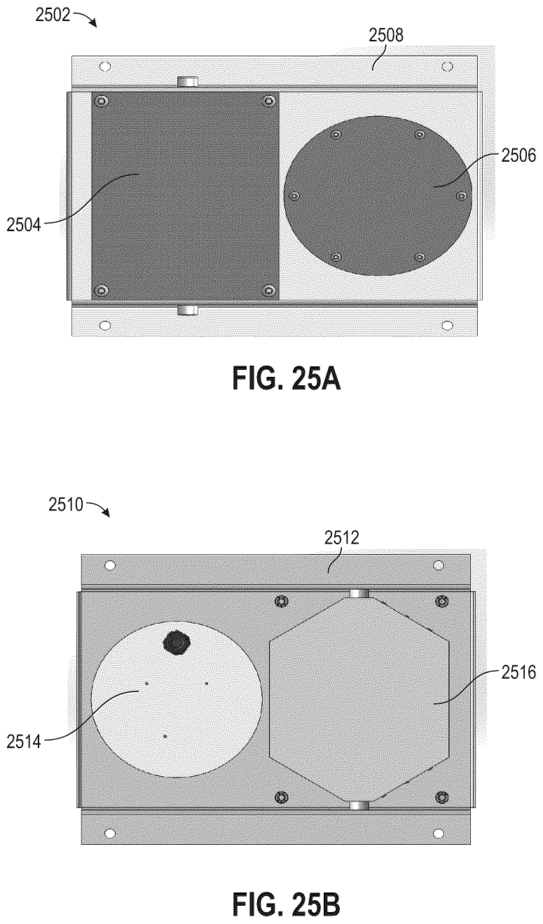

FIG. 25A is a side perspective view of an external victim alert system (EVAS) 2502, according to some examples. In the depicted example, the EVAS 2502 includes an external water resistant high temp resistant speaker and microphone system that provides two-way communication with victims, downed firefighters, suspects, and more. The EVAS 2502 utilizes software to filter out unwanted noise and assess human detection. In some examples, a machine learning model is trained on recordings that include human noises and the model is then used to identify noises received via the microphone. The EVAS 2502 includes a housing unit 2508 designed to mount externally on the hazardous environment robot system 100, housing both a speaker 2504 and a microphone 2506 for communication to survivors. The EVAS 2502 is thermally insulated from the robot chassis or metal cladding 104, using ceramic fiber blankets to protect the sensitive microphone and speaker from heat. The EVAS 2502 includes a robust sheet metal design having a mesh grille to prevent water ingress while allowing clear sound transmission. The housing unit 2508 is designed for quick installation and removal, using no more than four fasteners.

FIG. 25B is a side perspective view from behind a housing 2512 of an external victim alert system (EVAS) 2510, according to some examples. In the depicted example, the EVAS 2510 can be equivalent to the EVAS 2502 and thus includes an external water resistant high temp resistant speaker and microphone system that provides two-way communication via a speaker 2514 and a microphone 2516. As mentioned above the housing 2512 is also designed for quick installation and removal, using no more than four fasteners.

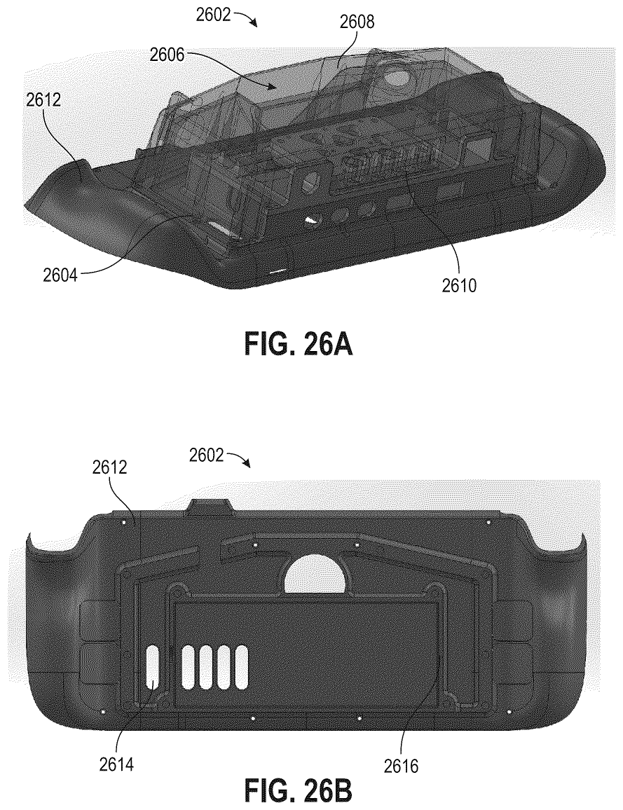

FIG. 26A is a perspective backside view of a firefighter control interface (FCI) 2602, according to some examples. In the depicted example, the FCI 2602 is a wireless controller that communicates wirelessly with the hazardous environment robot system 100. The FCI 2602 as show is a modified portable gaming console (e.g., Steamdeck) having certain the internal electronics and exterior hardware modified so that an external radio can be integrated into the design. This radio is meant to communicate control operations to the hazardous environment robot system 100 and to receive data and video streams from the sensors and cameras on hazardous environment robot system from great distances. Additionally, a computer dongle was integrated into the design to allow for more input/outputs.

Components of the FCI 2602 include a baseplate that modifies the standard back panel 2606 of the gaming console to allow for wire management, dongle housing, and a base 2604 for which a shroud can sit. An outer raised plane allows for threaded inserts to mount the shroud 2608. Internal housing constrains or otherwise hoses the dongle. An opening in the top center allows access to an internal fan utilizing the gaming consoles' cooling system to cool the external radio by adding a vent 2610 on top of the fan to pull air across the radio. A backplane 2612 includes handles on both ends suitable for more comfortably holding the FCI 2602 in use.

FIG. 26B illustrates a front perspective view of the FCI 2602, and more specifically, cutout details of the backplane 2612, according to some examples. A front left cutout 2614 houses an external radio key switch since power to the radio is pulled directly from the gaming console's power supply, it needs a way to be turned off and on so it doesn't continuously drain the battery. Additionally, the ability to turn on and off radio power allows firefighters to utilize their external radio by utilizing a built-in ethernet port. A rear cutout retains a Pololu buck converter used to step down power from the battery. Inputs from the gaming console are sent as outputs to a key switch. Center raised columns 2616 include mounting points for the radio mounting plate and a right housing contains an external ethernet port so that firefighters may connect their own external radio if preferred.

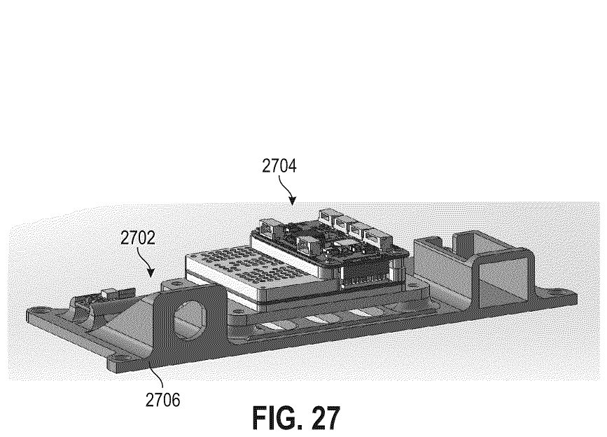

FIG. 27 illustrates a radio mount 2702 that is used to mount a radio 2704 into the FCI 2602, according to some examples. In the depicted example, a metal plate (e.g., aluminum plate) 2706 is used to mount the radio 2704. The metal plate 2706 raises the radio 2704 to the height of the vent so that air can be pulled over and under the radio 2704 more efficiently to keep it cool. The metal plate's thermal mass assists in keeping radio temperatures cool.

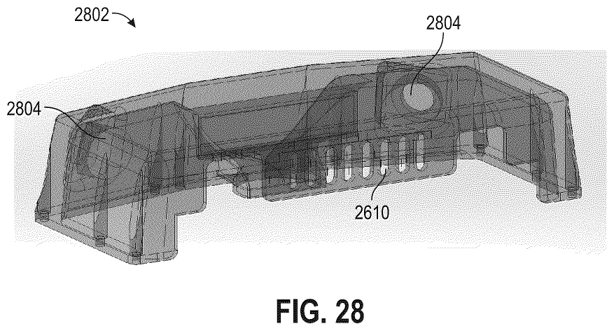

FIG. 28 is a perspective view of the shroud 2608, in accordance to some examples. In the depicted example, the shroud 2608 covers and contains almost all wiring and components of the FCI 2602. The shroud 2608 has radio antenna mounts 2804 and positions them at 45 degrees apart from one another as well as between 50% and 100% of the radio wavelength to reduce signal interference and optimize signal pickup. As mentioned above, the shroud 2608 also contains an air vent that guides air across the radio 2704 and pulls through external vents 2610 on the shroud 2608.

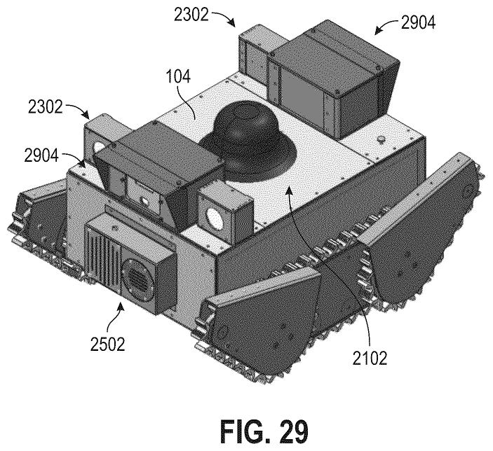

FIG. 29 illustrates an example of a hazardous environment robot system 2904, according to some examples. In the depicted example, a frame is covered in metal cladding 104. The EVAS 2502 is shown as disposed towards a front side of the hazardous environment robot system 2904 on the metal cladding 104. Three strobe/illumination units 2302 are shown, useful in illuminating areas around the hazardous environment robot system 2904. Two sensor housings are also shown, suitable for sensing various conditions, including IR camera sensing as described earlier. The communications antenna 2102 is also shown, disposed towards a middle section of a top metal cladding 104. As mentioned above, the high temperature resistant dielectric antenna 2102 allows for impact from falling obstacles and debris from various angles onto the antenna. The antenna 2102 additionally contains insulation (for heat), carbon blanket (for waterproofing), and a spring system to actively absorb shocks and thermally brake heat entering the robot's chassis.

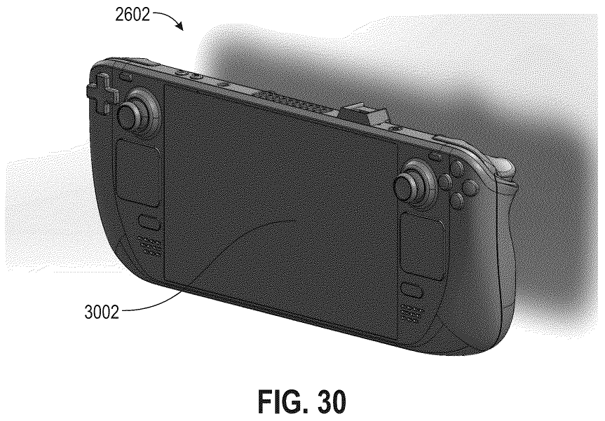

FIGS. 30-34 illustrate various view of a firefighter control interface (FCI), according to some examples. More specifically, FIG. 30 illustrates an example of the FCI 2602 in front perspective view that shows a video screen 3002 (e.g., LCD touchscreen) and various controls useful in operating the hazardous environment robot system (e.g., systems 100, 2904). Controls include multiple joysticks, buttons, and the like, that can be operated manually to move or otherwise control the hazardous environment robot system.

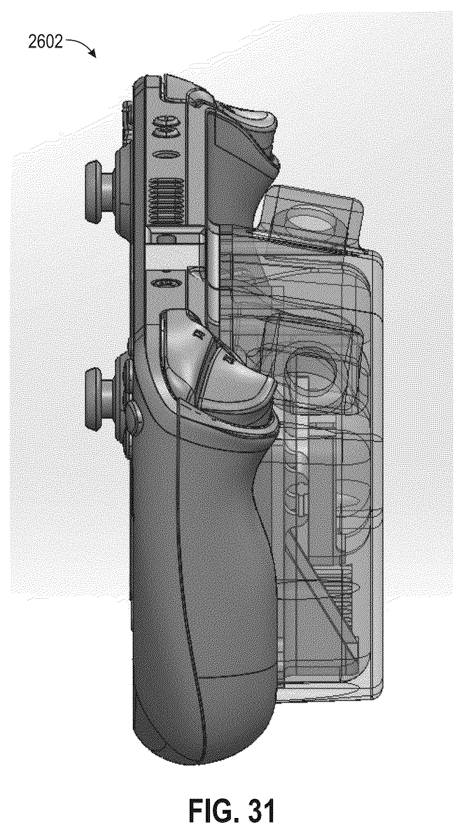

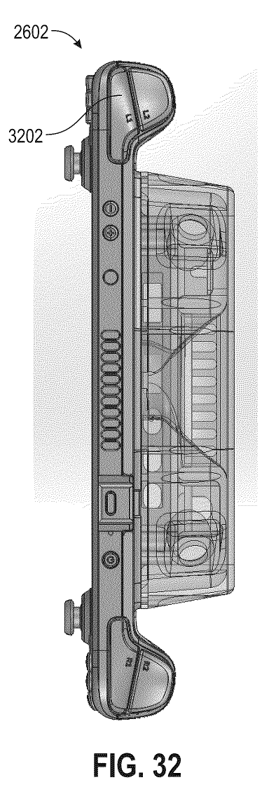

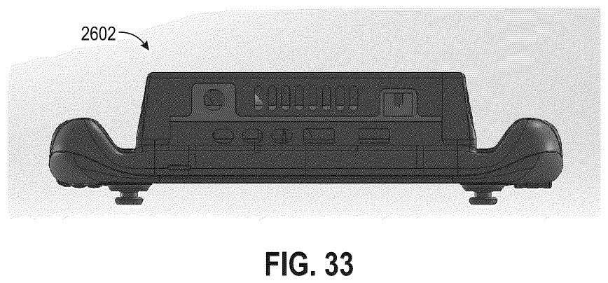

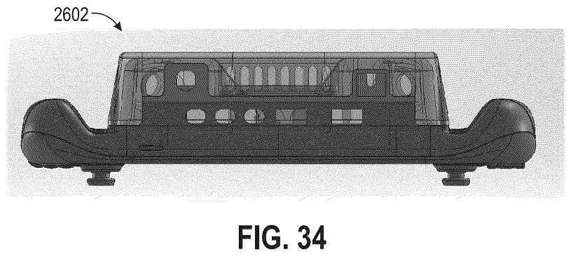

FIG. 31 illustrates an example of the FCI 2602 in side perspective view that shows further details of joysticks and buttons, as well as shapes useful in holding the FCI 2602 with both hands. FIG. 32 illustrates an example of the FCI 2602 in top perspective view, showing top buttons 3202 as well as views of the joystick, side handles, and back of the FCI 2602. FIG. 33 illustrates an example of the FCI 2602 in bottom perspective view, showing certain openings for air circulation, joysticks, buttons, and general shape of side handles. FIG. 34 illustrates an example of the FCI 2602 in bottom perspective view with some transparency on a back area showing internals of the FCI 2602, such as a radio mounting area.

The techniques described herein provide for a hazardous environment robot system that provides for heat resistance in hazardous environments, such as a residential or commercial fire. A multi-layered approach to thermal protection and specialized component design is presented, resulting a in temperature-hardened hazardous environment robot system. The robot system incorporates a High Reflectivity Surface Coating (HRSC), a Passive Thermal Protection System (PTPS), and an Electronics Thermal Protection System (ETPS) to manage both external and internal heat loads more effectively.

What is claimed is:

1. A mobile robot system, comprising:
a thermal protection system comprising an anti-radiation surface coating applied to an exterior of the mobile robot system;
a passive thermal protection system (PTPS) disposed within an inner structure of a frame of the mobile robot system;
an electronics thermal protection system (ETPS) disposed within the PTPS;
a temperature-hardened sensor housing comprising at least one sensor disposed externally on the frame; and
a control interface configured to control a mobile operation of the mobile robot system.

2. The mobile robot system of claim 1, wherein the PTPS comprises a fire-temperature insulation completely enclosing a conduction zone insulation.

3. The mobile robot system of claim 2, wherein the fire-temperature insulation comprises a first ceramic-based fire blanket.

4. The mobile robot system of claim 3, wherein the ceramic-based fire blanket comprises a combination of alumina and silica.

5. The mobile robot system of claim 3, wherein the conduction zone insulation comprises a second ceramic-based fire blanket.

6. The mobile robot system of claim 2, wherein the ETPS is disposed completely inside of the conduction zone insulation.

7. The mobile robot system of claim 2, wherein the ETPS comprises a capsule enclosing electronic components.

8. The mobile robot system of claim 7, wherein the capsule comprises an inner box enclosing the electronic components, an outer box enclosing the inner box, and a phase change material (PCM) disposed between the inner box and the outer box, wherein the PCM is configured to store heat during an endothermic chemical reaction.

9. The mobile robot system of claim 8, wherein the inner box comprises a first metal box, and the outer box comprises a second metal box.

10. The mobile robot system of claim 7, wherein the electronic components comprise a motor drive controller configured to drive one or more motor configured to move the mobile robot, and a radio configured to communicate with an external firefighter control interface (FCI).

11. The mobile robot system of claim 1, comprising an electric motor operatively connected to the control interface, wherein the control interface is configured to control the electric motor, and wherein the control interface comprises a motor drive controller included in the ETPS and configured to move the mobile robot via the electric motor.

12. The mobile robot system of claim 11, wherein the electric motor comprises a housing filled with a phase change material (PCM) and wherein the housing encloses an inner electric motor configured to move the mobile robot.

13. The mobile robot system of claim 11, comprising a coaxial spindle mechanically coupled to the electric motor on an first end and to a tread system and a flipper arm on a second end opposite the first end, wherein the coaxial spindle is configured to turn the tread system to move the mobile robot and to raise and to lower the flipper arm, and wherein the tread system is rotatively disposed onto the flipper arm.

14. The mobile robot system of claim 13, wherein the coaxial spindle comprises one or more mica washers to minimize or eliminate metal to metal contact.

15. The mobile robot system of claim 13, wherein the tread system comprises a plurality of metal treads, each metal tread of the plurality of treads comprising two arms disposed at about 90 degrees from each other.

16. The mobile robot system of claim 1, comprising one or more sensors, the one or more sensors comprising a thermal sensor, a video sensor, and a gas sensor, and comprising a 2-way audio system, a long range wireless communications radio, and inertial measurement unit, or a combination thereof.

17. The mobile robot system of claim 2, wherein the fire-temperature insulation comprises a temperature rating to operate at 600 C or more for 15 minutes or more, or 200 C or more for 60 minutes or more.

18. The mobile robot system of claim 1, comprising an external victim alert system (EVAS) having a speaker and a microphone, a strobe/illumination unit having a source of light, and an antenna system.

19. A thermal protection system for a mobile robot system comprising:
an anti-radiation surface coating applied to an exterior of the mobile robot system;
a passive thermal protection system (PTPS) disposed within an inner structure of a frame of the mobile robot system;
an electronics thermal protection system (ETPS) disposed within the PTPS; and
a temperature-hardened sensor housing comprising at least one sensor disposed externally on the frame.

20. A method of manufacturing a mobile robotic system, comprising:
applying a thermal protection system comprising an anti-radiation surface coating to an exterior frame of the robotic system;
manufacturing a frame inner structure;
disposing a passive thermal protection system (PTPS) within the frame inner structure;
disposing an electronics thermal protection system (ETPS) within the PTPS;
disposing a temperature-hardened sensor housing comprising at least one sensor onto the frame; and
providing a control interface configured to control a mobile operation of the mobile robot system.
